(19) United States
(12) Patent Application Publication
(10) Pub. No.: US 2012/0152576 A1
(43) Pub. Date: Jun. 21, 2012

(54) EXTRA AREA DOWN-HOLE HAMMER APPARATUS AND METHOD

(75) Inventors: Grey Bassinger, Georgetown, TX (US); Ross Darren Bassinger, Austin, TX (US); Ross Darren Bassinger, Austin, TX (US); Joseph Robert Goebel, Mount Shasta, CA (US)

(73) Assignee: VALHALLA TECHNOLOGIES, LLC, Austin, TX (US)

(21) Appl. No.: 13/326,662

(22) Filed: Dec. 15, 2011

Related U.S. Application Data
(60) Provisional application No. 61/423,525, filed on Dec. 15, 2010.

(51) Int. Cl. E21B 4/14; F16K 31/122; E21B 1/24

(52) U.S. Cl. 173/1; 173/200; 251/63

(57) ABSTRACT

Provided is an actuator and method for operating an actuator. For example, the actuator may have first and second operating phases, a housing having an opening receiving pressure, a piston inside the housing for moving along inside the housing and positioned therein for creating a first chamber between one end of the piston and the housing and a second chamber between the other end of the piston and the housing, first and second ports each capable of communicating with the pressure source during a different one of the first and second phases, an extra area chamber between the piston and the housing. In the first phase the first port may be communicating with the opening for providing pressure to the first and extra area chambers. In the second phase the second port may be communicating with the opening for providing pressure to the second chamber.

### CROSS-REFERENCE TO RELATED APPLICATIONS

This application claims the benefit of U.S. Provisional Application No. 61/423525, filed Dec. 15, 2010, which is incorporated herein by reference in its entirety.

### FIELD OF THE INVENTION

The present invention relates generally to pressurized fluid driven devices, such as pneumatic tools, and more particularly to a pressurized fluid driven down-hole hammer apparatus and method that provides increased hammering force.

### BACKGROUND

Down-hole hammers, which are also called down-the-hole or DTH hammers, have long been known in the art. Such devices utilize pressurized fluid to actuate a piston housed within the tool. The piston produces axial, percussive forces that destroy rock. The force produced by the piston in a conventional down-hole hammer is proportional to the pressure of the pressurized fluid and the area of the piston acted on by the fluid in the direction of the piston's motion. Thus, the force may be increased by increasing the fluid pressure, by increasing the piston area, or by increasing both. The pressurized fluid is generally air, but other fluids, including but not limited to water, may be used depending on the application.

There are, however, deficiencies associated with conventional down-hole hammers. For example, the maximum force produced by a conventional down-hole hammer is generally limited by the size of the hole to be drilled. More specifically, the size of the hole to be drilled limits the size of the hammer's housing, which in turn limits the area of the piston acted on by the pressurized fluid. In addition, the maximum force of conventional hammers is also limited by the pressure of the working fluid. In some situations it may not be practical, or even possible, to increase the pressure of the working fluid. For example, increasing the pressure would lead to increased energy consumption by the compressor, and thus would increase the overall cost of the drilling operation. Higher pressures may also exceed the hammer's structural design limitations, and thus lead to structural failures or decreased tool life. In other words, even when there are no dimensional constraints, there are generally other constraints that limit the maximum potential force produced by conventional down-hole hammers. Furthermore, it is often difficult to optimize the dimensions, energy consumption, working fluid pressure, and axial forces of conventional down-hole hammers. Thus, there currently exists a need for an improved down-hole hammer that alleviates deficiencies associated with conventional down-hole hammers.

### SUMMARY

One embodiment of an extra area down-hole hammer apparatus provides a pressure operated actuator that operates in a first and second phase. The pressure operated actuator includes a housing having a pressure source opening for receiving a source of pressure. Further, the pressure operated actuator includes a piston inside the housing such that the piston moves along the inside of the housing. The piston may be positioned in the housing so that a first chamber may be created between one end of the piston and the housing and a second chamber may be created between the other end of the piston and the housing. The pressure operated actuator further includes a first port capable of being in communication with the pressure source opening during the first phase of the pressure operated actuator and a second port capable of being in communication with the pressure source opening during the second phase of the pressure operated actuator. In addition, the pressure operated actuator includes a first extra area chamber between the piston and the housing. Moreover, the pressure source opening and piston are configured in a manner so that in the first phase of the pressure operated actuator, the first port may be in communication with the pressure source opening for receiving the source of pressure and allowing the source of pressure to be provided to the first and first extra area chambers. In the second phase of the pressure operated actuator, the second port may be in communication with the pressure source opening for receiving the source of pressure and allowing the source of pressure to be provided to the second chamber.

Another embodiment provides a down-hole hammer comprising a housing having an inner dimension, and a source opening within the housing for receiving a source of fluid for creating movement in the hammer. In addition, the hammer comprises a piston having an inner dimension, an outer dimension, and a reduced outer dimension. The piston is adapted to fit inside the housing such that the outer dimension of the piston may be movable along and within the inner dimension of the housing. The housing and piston may be generally tubular or cylindrical in shape, but other shapes are feasible and considered within the scope of the invention. Further, the piston comprises a top surface defining a first pressure chamber adjacent a top portion of the housing, and a bottom surface defining a second pressure chamber adjacent a bottom portion of the housing. The hammer also comprises an extra area component positioned between the housing and the piston such that the reduced outer dimension of the piston may be movable along the extra area component, and wherein a surface of the extra area component together with the reduced outer dimension of the piston and the inner dimension of the housing defines an extra area chamber. The piston also comprises: a first port in fluid communication with the source opening, the first port extending between the inner and outer dimensions of the piston; a second port in fluid communication with the first port that extends from the first port along a portion of the length of the piston; and a third port in fluid communication with the second port that extends from the second port toward the outer dimension of the piston and in communication with the extra area chamber. The working fluid may be air, a gas, water or another fluid depending upon the particular application.

Yet another embodiment provides a method of operating a piston-driven, down-hole hammer apparatus. The piston-driven hammer may have a tubular piston with an inner diameter, an outer diameter, and reduced outer diameter. The piston may be movable within a housing that has an inner diameter, and the piston may operate in an upstroke phase and a downstroke phase. During the downstroke phase the method comprises receiving into the piston fluid having a first pressure (or flow rate); providing the received fluid to an area between an upper outer surface of the piston and an upper inner surface of the housing to create a force that drives the piston in a downward motion; and providing the received fluid through porting to an extra area chamber between the reduced outer diameter of the piston and the inner diameter of the housing, the provided fluid in the extra area chamber creating an additional force that drives the piston in a downward motion. During the upstroke phase the method comprises receiving into the piston fluid having a second pressure (or flow rate); and providing the received fluid to an area between a lower outer surface of the piston and a lower inner surface of the housing to create a force that drives the piston in an upward motion.

Thus, provided is an improved down-hole hammer apparatus and method for increasing energy delivered to a piston. This invention comprises adding extra area to devices whose work, velocity and energy transfer may have been limited by the internal dimensions of their housings. The invention may further comprise extra area feed bores in conjunction with an extra area component so that the pressurized fluid may be fed between the annulus that may be articulated between the component and the piston face diameter resulting in increased velocity of the piston. This invention and method may be implemented in an array of different applications and contexts that involve fluid-driven, pistons.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1 is a cross-sectional view of a portion of an extra area down-hole hammer apparatus.

FIG. 2A is a cross-sectional view of another portion of the extra area down-hole hammer apparatus of FIG. 1.

FIG. 2B is a cross-sectional view of an alternative embodiment of the portion of the extra area down-hole hammer apparatus shown in FIG. 2A.

FIG. 3 is a cross-sectional view of another portion of the extra area down-hole hammer apparatus of FIG. 1.

FIG. 4 is a cross-sectional view of still another portion of the extra area down-hole hammer apparatus of FIG. 1.

FIG. 5 is a longitudinal view of the extra area ring shown in FIGS. 2A and 2B.

FIG. 6 is a cross-sectional view of the extra area ring taken along the line 6-6 of FIG. 5.

FIG. 7 is a side view of the extra area ring shown in FIG. 5.

FIG. 8 is a cross-sectional view of the extra area down-hole hammer apparatus taken along the line 8-8 of FIG. 2A.

FIG. 9 is a flowchart of a method of operating a down-hole hammer apparatus.

FIG. 10 is a flowchart of another method of operating a down-hole hammer apparatus.

### DETAILED DESCRIPTION OF THE PREFERRED EMBODIMENTS

Referring now to the drawings, wherein like reference numerals designate identical or corresponding parts throughout the several views, preferred embodiments are described.

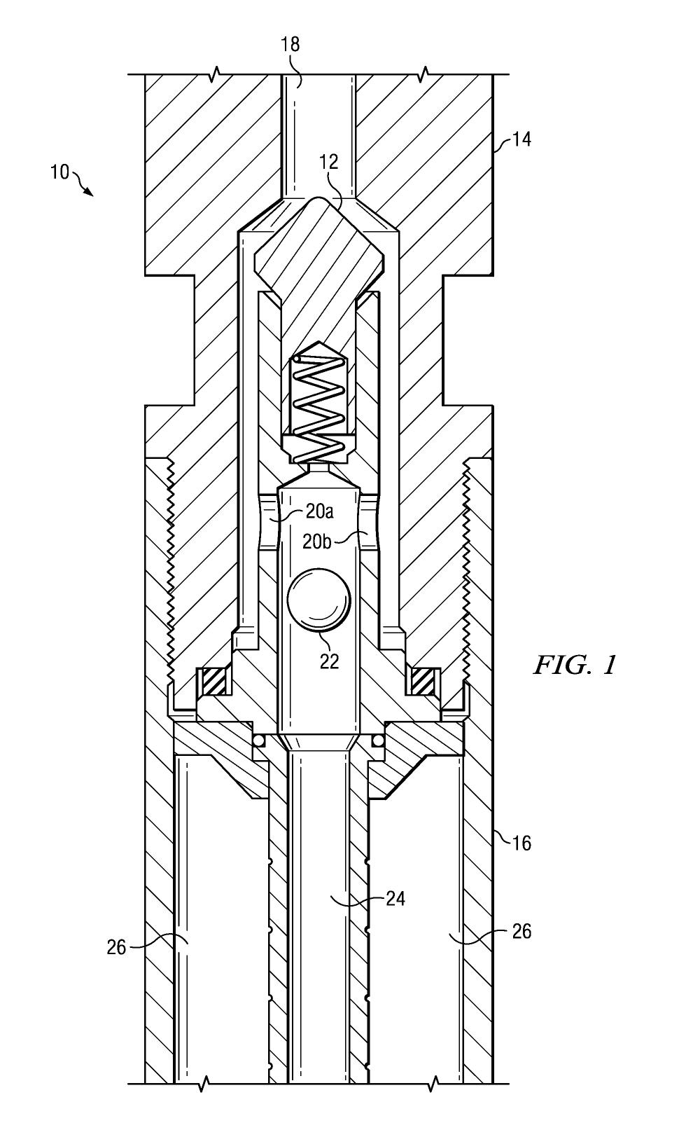

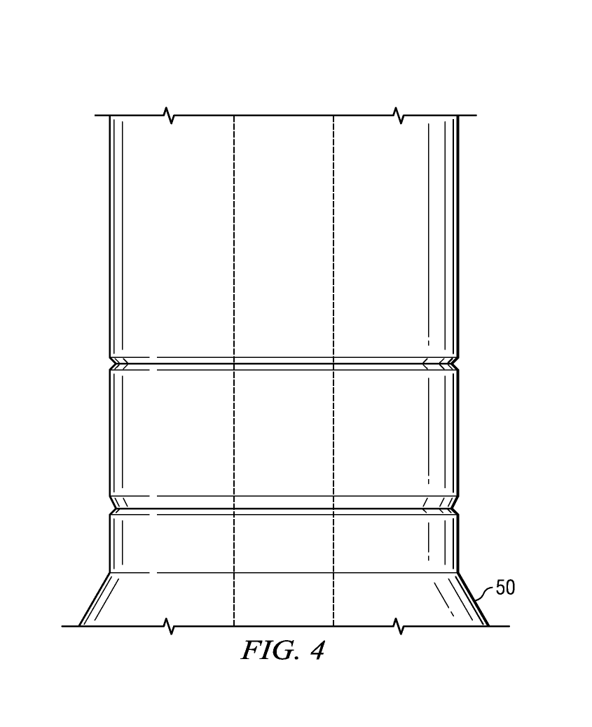

Referring to FIGS. 1-5, there is illustrated an improved down-hole, pressure actuated hammer apparatus in accordance with the invention. The hammer apparatus 10 includes an elongated generally cylindrical housing member 16 having internal and external walls. Housing member 16 includes a helical threaded portion for connecting housing member 16 to a top subassembly 14, having a check valve dart 12. A piston 11 may be disposed in housing member 16 in free sliding, but close fitting relationship to the interior wall of housing member 16. In alternative embodiments, multiple pistons 11 may be used.

An elongated central passage 18 extends through the top subassembly 14 and may be adapted for operatively conducting air or fluid throughout the hammer apparatus 10. Feed tube 24 may be positioned within housing member 16 and may be operatively configured to receive the air or fluid from central passage 18. Feed tube 24 includes apertures 20a, 20b, and 22 at an upper portion of the feed tube 24 and apertures 25a, 25b and 23 at a lower portion of the feed tube 24. In operation, central passage 18 may be configured to deliver compressed air or fluid through apertures 20a and 20b and into feed tube 24.

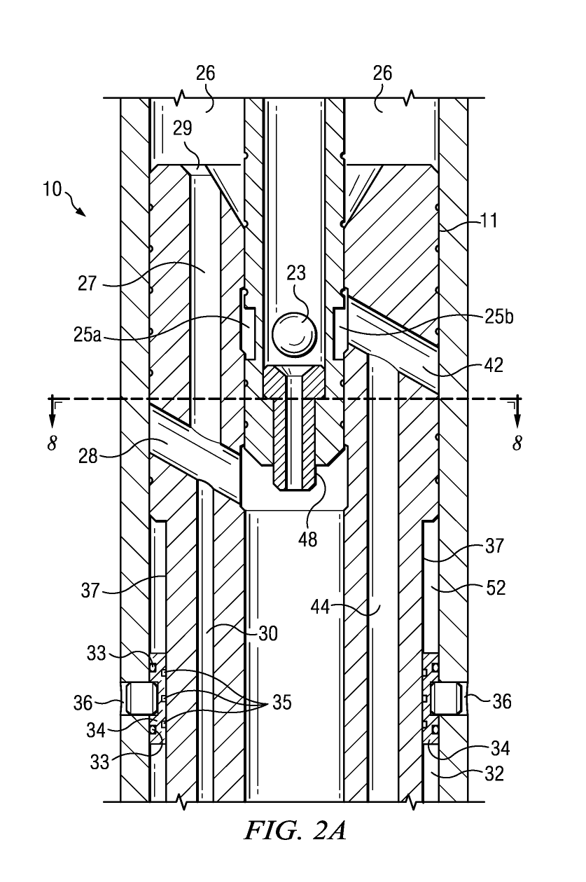

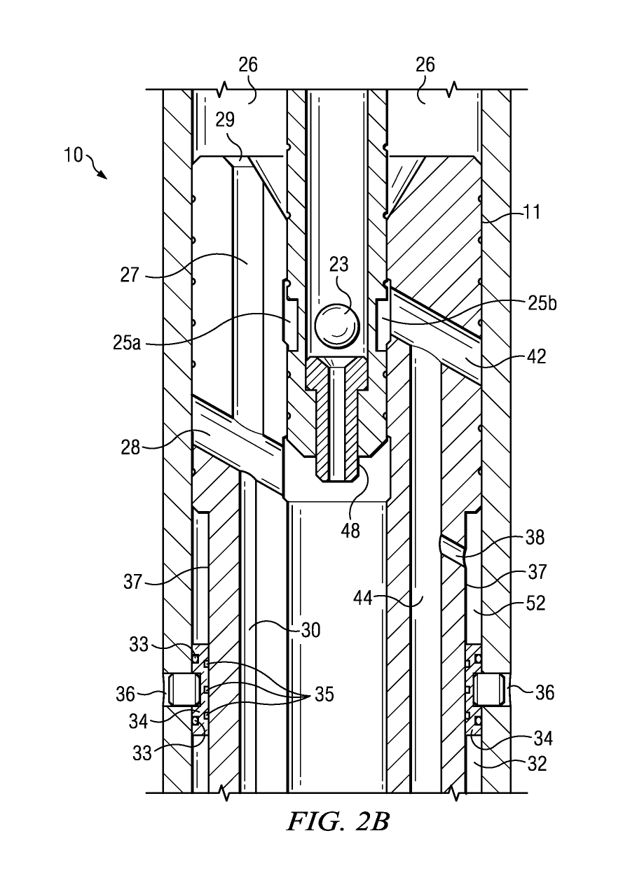

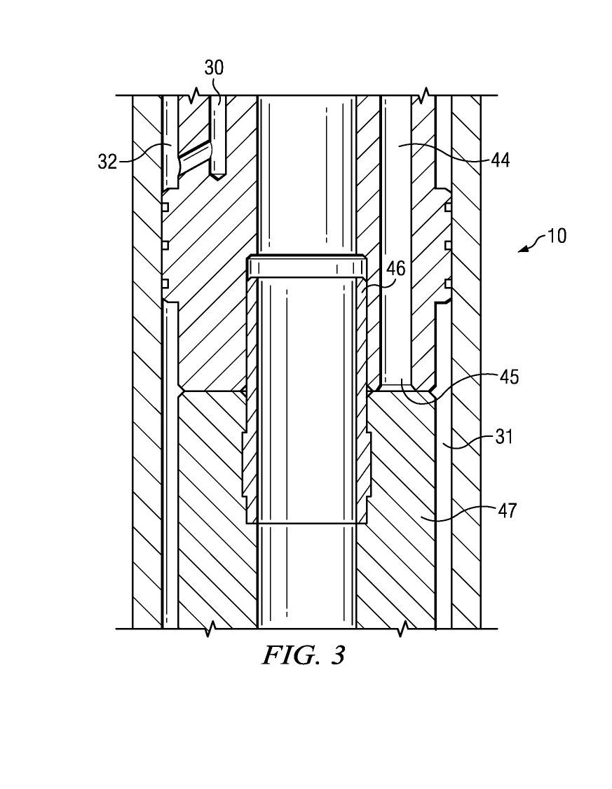

FIG. 2A is a cross-sectional view of another portion of the extra area down-hole hammer apparatus 10 of FIG. 1. Depending on the position of the piston 11, the compressed air or fluid flows into first pressure chamber 26 formed at the top end of piston 11 or a second pressure chamber 31 at the bottom end of piston 11. When aperture 25a is in gas or fluid communication with port 28, the compressed air or fluid may flow through ports 28 and 27, and then through opening 29, into the first pressure chamber 26. Also referring to FIG. 3 is a cross-sectional view of another portion of the extra area down-hole hammer apparatus 10 of FIG. 1. FIG. 3 shows the piston 11 abutting a drill bit or drill bit housing or bit shank 47 at the bottom of its downstroke phase. As the piston 11 transitions to its upstroke phase, the piston 11 moves upward relative to the bit housing or bit shank 47, creating a space between the bottom of the piston 11 and the bit housing or bit shank 47. At or near the beginning of the upstroke phase, aperture 25b becomes in gas or fluid communication with port 42. The compressed air or fluid may flow through ports 42 and 44, and then through opening 45, into the second pressure chamber 31 that includes spacing between the bottom of the piston 11 and the bit housing or bit shank 47. Chamber 26 is arranged to drive piston 11 in a downward direction. The chamber 31 formed at the opposite end of the drive piston 11 is arranged to drive piston 11 in an upward direction.

In addition, FIG. 3 shows an exhauster or foot valve portion 46. As the bottom portion of the piston 11 moves along the upper edge of the exhauster 46, there may be venting of pressurized fluid from chamber 31. This may provide a net decrease in fluid pressure that (in conjunction with chamber 26 being pressurized) may drive the piston 11 downward toward the bit housing or bit shank 47. Also, referring to FIG. 2A, shown is a choke portion 48 that may be used to regulate the flow of fluid, such as compressed air, that may travel down the bottom of the hammer apparatus 10 toward the bit housing or bit shank 47. The choke portion 48 may regulate the pressure of fluid that may be used for actuating the hammer apparatus 10. Further, the choke portion 48 may regulate the pressure of fluid that may be used for cleaning the drill hole cuttings and cooling drill bit 47 during operation of the hammer apparatus 10.

In a conventional hammer apparatus known in the art, the amount of downward or upward force applied to the piston may be limited to the surface area of the chambers formed above and below the piston, respectively. In particular, the force may be equal to pressure (often measured in pounds per square inch) multiplied by the surface area. Thus, the maximum force of conventional hammers is generally limited by the internal diameter of the housing.

The embodiments discussed below provide an increased force to the piston without increasing the diameter of housing 16. According to this improvement, piston 11 may include at least one reduced diameter portion 37 along an external wall of piston 11 to form an annulus between an external wall of piston 11 and an internal wall of housing member 16. An extra area component, for example extra area ring 34, forms a seal between an upper extra area chamber 52 and a lower extra area chamber 32 in the annulus. Extra area ring 34 can be held in place with extra area component fasteners, such as extra area set pins 36. The extra area ring 34 and extra area set pins 36 may comprise, without limitation, metal, composite materials or the like. Alternatively, other sealing means known in the art may be used instead of extra area ring 34 and extra area set pins 36. According to at least one embodiment, the extra area ring 34 and extra area set pins 36 are operatively removable such that the seal may added to, or removed from, housing 16. It is to be understood that the seal provided by the extra area ring 34 and extra area set pins 36 may be provided by other sealing and closure members.

The extra area component may take on alternative forms. For example, the extra area component may be any structure that forms a suitable partition or division between upper extra area chamber 52 and lower extra area chamber 32. For example, the extra area component may be an integral part of the housing member 16. In another embodiment the extra area component may include a shoulder attached to the housing member 16. The extra area component may also be a rib that projects from the inner wall of the housing member 16. In this instance, the rib may be an extra area component that may be integrally connected to the housing member 16 and may function similar to the extra area ring 34.

In addition, the apparatus may utilize multiple extra area components. As an example, some embodiments may include multiple extra area rings 34. In yet another embodiment that includes more than one piston 11, one or more of the pistons 11 may include one or more extra area components, for example, multiple extra area rings 34.The extra area component fasteners may also take on various forms to accomplish fastening, or keeping together, the extra area component. For instance, in one embodiment the extra area component, such as an extra area ring 34, may be fastened using “O” rings. In an alternative embodiment, snap rings may be used. In yet another embodiment, an alternative method or means may be employed for fastening the extra area component.

The extra area ring 34 may include grooves 33 and 35 as shown in FIG. 2A. The grooves 33 may receive “O” rings that can improve the seal between the outer diameter of the extra area component, such as extra area ring 34, and the inner diameter of the housing member 16. For example, the “O” rings along the grooves 33 may prevent air, gas, or fluid leakage between the inner diameter of the housing member 16 and the outer diameter of the extra area component, such as the extra area ring 34. The grooves 35 may be labyrinth grooves. The grooves 35 may provide an improved lubrication reservoir to cool the components. In addition, the grooves 35 may house a lubricant, for example oil. The lubricant in the grooves 35 may act as a seal and also facilitate movement of the piston 11 within the housing member 16. Further, in operation the grooves 35 may provide for turbidity. For example, in operation the grooves 35 may provide a turbidity barrier or curtain to capture fluid. Alternative methods for sealing and facilitating movement may be provided. In one embodiment, one or more of the grooves 35 may be constructed to receive an “O” ring, in a similar manner as the grooves 33. In some embodiments, one or more grooves may be provided along the inner diameter of the extra area ring 34 and, for example, each may respectively receive an “O” ring for providing a seal while the one or more grooves may also provide a sealing means and or also include a lubricant for aiding movement of the piston 11 within the housing member 16. Other embodiments may include an alternative sealing means provided along the extra area component. For example, other embodiments may include alternative sealing means provided along the inner and outer diameters of the extra area ring 34.

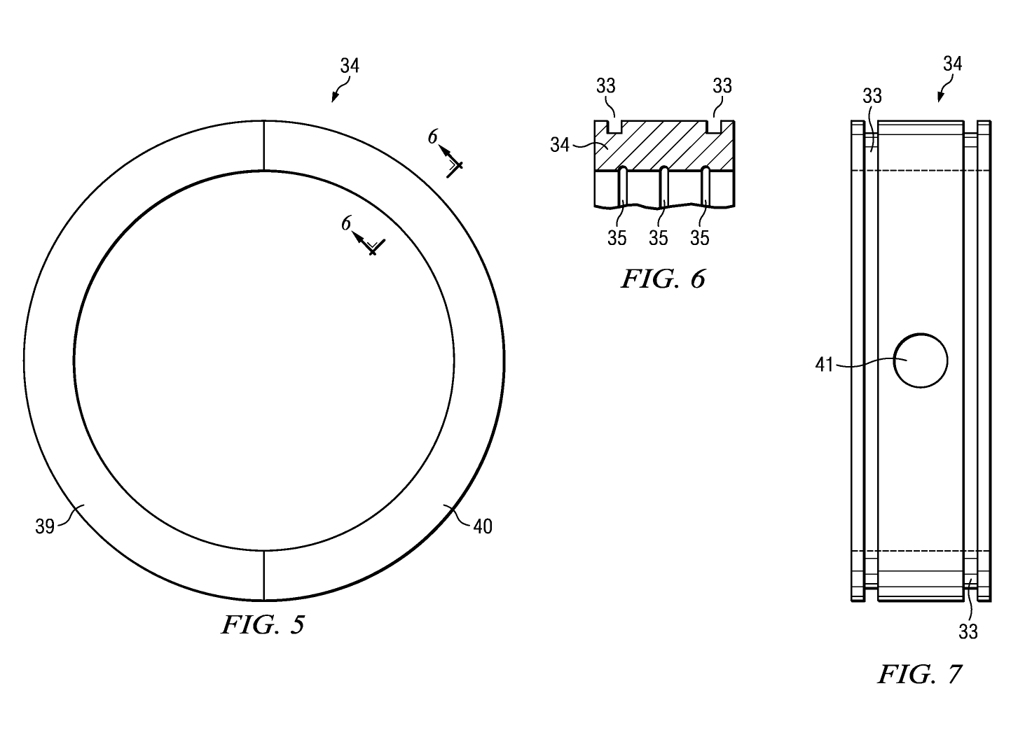

Referring to FIGS. 5-7, FIG. 5 is a longitudinal view of the extra area ring 34 shown in FIGS. 2A and 2B. FIG. 6 is a cross-sectional view of the extra area ring 34 taken along the line 6-6 of FIG. 5. FIG. 7 is a side view of the extra area ring 34 shown in FIG. 5. As illustrated in FIG. 5, the extra area ring 34 may comprise ring halves 39 and 40. The ring halves 39 and 40 may be formed using various fabrication methods, some of which are explained in more detail below. Referring to FIG. 6, the outer diameter of the ring 34 may include grooves 33 for receiving an “O” ring or other seal as discussed above. In addition, the inner diameter of the ring 34 may include grooves 35 that may be labyrinth grooves that act to provide a seal and lubricant housing for aiding movement of the piston 11, as discussed above. Moreover, in alternative embodiments, the inner diameter of the ring 34 may include one or more grooves that may also receive an “O” ring to provide a seal, as discussed above. Referring to FIG. 7, either or both of ring halves 39 and 40 may include a set pin hole 41 for receiving a set pin 36. The extra area ring 34 may be formed by joining the ring halves 39 and 40.

The extra area ring 34 may provide a simple and effective assembly and disassembly method. For example, in one embodiment, the ring halves 39 and 40 may be inserted and removed with the piston 11. Moreover, the ring halves 39 and 40 may be joined to form the extra area ring 34 in different ways. For example, in one embodiment, the set pins 36 may be inserted from the outside of the housing 16 and secured with welding. Alternatively, the pins 36 may be secured with set screws or keys. Further, in an alternative embodiment, the ring halves 39 and 40 may be secured by spring loaded pins that extend out from the ring halves 39 and 40 to lock the extra area ring 34 in place. In some embodiments, the spring loaded pins used for securing the ring halves 39 and 40 may be retractable by using an access hole through the cylinder housing 16. In alternative embodiments, the spring loaded pins used for securing the ring halves 39 and 40 may be retractable by using a key system between the piston 11 and the extra area ring 34.

In one embodiment, the extra area ring 34 may have a Total Indicator Reading (“TIR”) of no more than 0.003 inches on the outer circumference and the inner circumference of the ring. In a preferred embodiment, the extra area ring 34 may have a TIR of no more than 0.001 inches on the outer circumference and the inner circumference of the ring. Using an extra area ring with a TIR of no more than 0.001 inches provides an extra area surface that may allow for a single piece hammer piston 11 design that maximizes strength and durability of the piston 11. Further, an extra area ring 34 may provide a very high tolerance fit which may reduce fluid leakage between chambers. Moreover, an extra area ring 34 may provide a consistent radial fit between the piston 11 and extra area surfaces for reduced wear, longer life and higher performance.

There are various methods for fabricating an extra area ring 34. For example, a “cut before machining” fabrication method may be used to form an extra area ring 34 having a TIR within the limits described above. For example, the cut before machining fabrication method may include cutting a disk from a piece of cylindrical bar stock. The disk may be then cut or sawed in half to form two half disks. Then, the two half disks are placed together and a hole or bore is machined in the center of the disks form a ring shape (i.e., similar to a doughnut). The inner circumference and the outer circumference are machined so that, upon completion, the ring will have a concentricity within the TIR limits discussed above. This ring may be used to form an extra area ring 34 by joining both halves of the ring using, for example, extra area pins 36 or various other methods as explained above. As an alternative, the ring may be formed from cylindrical tube stock, rather than cylindrical bar stock. If cylindrical tube stock is used, it will not be necessary to machine the hole or bore in the center of the work piece before machining the inner and outer circumferences. Other methods for fabricating extra area components, such as extra area ring 34, may also be used.

Referring back to FIGS. 2A and 3, in operation, depending on the position of the piston 11, the compressed air or fluid may flow into lower extra area chamber 32. The compressed air or fluid may be received at aperture 25a and may flow into the lower extra area chamber 32 through port 28 and then 30 in the piston 11. Lower extra area chamber 32 is arranged to also drive piston 11 in a downward direction. The additional area provided by lower extra area chamber 32 increases the total area and thereby increases the downward force provided to piston 11. As such, the improvement provided by the embodiments increases the force to the piston 11 without increasing the diameter of housing 16.

The embodiments may allow for extra area forces to be applied to either or both of the upward and downward strokes of the piston 11. For example, FIG. 2B is a cross-sectional view of an alternative embodiment of the portion of the extra area down-hole hammer apparatus 10 that is shown in FIG. 2A. The portion of the extra area down-hole hammer apparatus 10 shown in FIG. 2B is similar to the portion of the extra area down-hole apparatus 10 shown in FIG. 2A. Therefore, the explanation that follows focuses on the differences. Depending on the position of the piston 11, the compressed air or another fluid may flow into upper extra area chamber 52. The compressed air or fluid may be received at aperture 25b and may flow into upper extra area chamber 52 through port 42, then port 44 and then port 38 in the piston 11. Upper extra area chamber 52 is arranged to also drive piston 11 in an upward direction. The additional area provided by upper extra area chamber 52 increases the total area and thereby increases the upper force provided to piston 11. As such, the improvement provided by the embodiments increases the force to the piston 11 without increasing the diameter of housing 16. Consequently, the embodiment of the piston 11 illustrated in FIG. 2B may allow for extra area forces to be applied to both the upward and downward strokes of the piston 11.

Referring back to FIGS. 2A, 2B, and 3, the disclosed embodiments illustrate porting simplicity. For example, the embodiments may use a single central source of fluid, such as compressed air. In addition, porting may be accomplished within the piston. For example, porting may be integral to the piston 11. This eliminates the need for any special porting sleeves or shells between the piston 11 and the housing cylinder 16. In turn, the porting simplicity features of the embodiments may provide reduced manufacturing costs, increased reliability, durability, and more efficient air flow. In alternative embodiments, more than one source of fluid may be used. Further, in other embodiments, porting may be accomplished by areas integral to the piston along with other areas. In additional embodiments, porting may be accomplished by areas that may not be integral to the piston.

As illustrated in FIGS. 2A, 2B and 3, porting may be accomplished within the piston 11, and piston 11 can stroke in either direction (upward or downward) while in fluid communication with a single central source of fluid. For example, looking at FIG. 2A in greater detail, first focus on the right side of the diagram. The right side of the diagram shows a portion of the piston 11 where the porting is that drives the upstroke phase. FIG. 2A illustrates the piston 11 at about the beginning of the upstroke phase. At about the beginning of the upstroke phase, the port 42 may be in fluid communication with the aperture 25b. Moreover, ports 44 and 38 may be in fluid communication with port 42. Fluid may be received at aperture 25b and may flow into ports 42, 44, and 38. In addition, fluid may flow into extra area chamber 52 from port 38. The fluid flowing into the extra area chamber 52 may provide an extra area force that drives the piston 11 upward, relative to the diagram illustrated in FIG. 2A. As the piston 11 reaches its peak in the upstroke phase the piston 11 begins its downstroke phase.

The left side of the diagram shown in FIG. 2A shows the portion of the piston 11 where the porting is that drives the downstroke phase. During operation, as the piston 11 cycles from the upstroke phase to the downstroke phase, the piston 11 may receive fluid at aperture 25a which may be in fluid communication with the same source as the aperture 25b during the upstroke phase. In alternative embodiments, different fluid sources may be used for the different phases of the piston 11. Although not illustrated in FIG. 2A, the ports 27, 28, and 30 may be in fluid communication with aperture 25a at or near the beginning of the downstroke phase. At or near the beginning of the downstroke phase, fluid may be received at aperture 25a and flows into ports 27, 28, and 30. In addition, fluid may flow into extra area chamber 32 from port 30. The fluid flowing into the extra area chamber 32 may provide an extra area force that drives the piston 11 downward, relative to the diagram illustrated in FIG. 2A. At or near the point where the piston 11 completes its downstroke phase, the port 42 in the upstroke portion of the piston 11 again becomes in fluid communication with port 25b and the piston 11 begins an upstroke phase. As such, the embodiments of FIGS. 2A and 2B illustrate that porting may be accomplished within the piston, and that the piston 11 may stroke in either direction (up or down) while in fluid communication with a single central source of fluid.

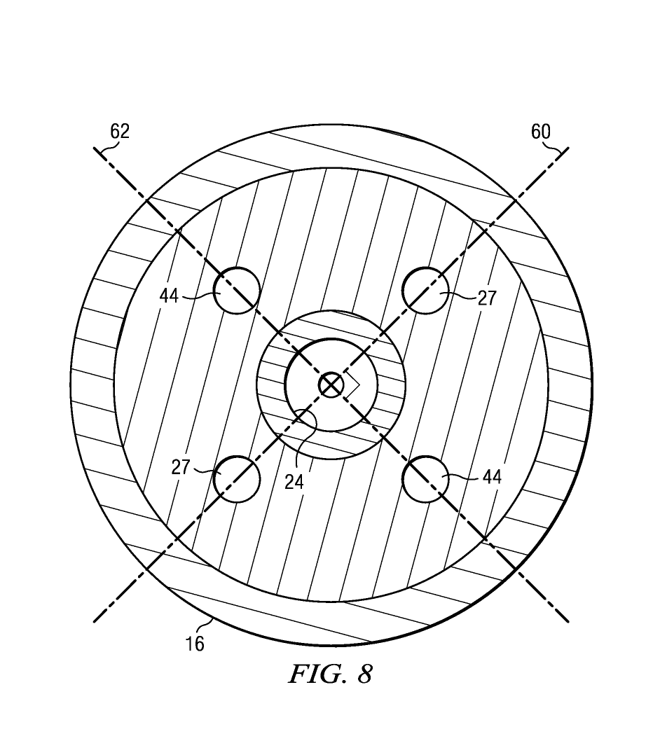

Referring to FIGS. 2A and 8, what follows now is a brief discussion of the orientation of the ports 27 and 44. As discussed above, port 27 is relevant to the downstroke phase of the hammer piston 11 and port 44 is relevant to the upstroke phase of the piston 11. FIG. 8 is a cross-sectional view of the extra area down-hole hammer apparatus 10 taken along the line 8-8 of FIG. 2A. FIG. 8 shows imaginary lines 60 and 62. Imaginary line 60 is defined by the line that bisects the midpoints of ports 27. Imaginary line 62 is defined by the line that bisects the midpoints of ports 44. Imaginary lines 60 and 62 are perpendicular to one another and therefore, each of the ports 27 and 44 are said to be separated or isolated by 90 degrees. In alternative embodiments, each of the ports 27 and 44 can be separated by different angles.

A method of improving the operating force of a down-hole hammer using the above-described apparatus is also envisioned. According to this method, the operating force may be increased by increasing the area provided to an internal piston by including one or more separated, extra area chambers formed between the piston and an internal wall of the down-hole hammer housing.

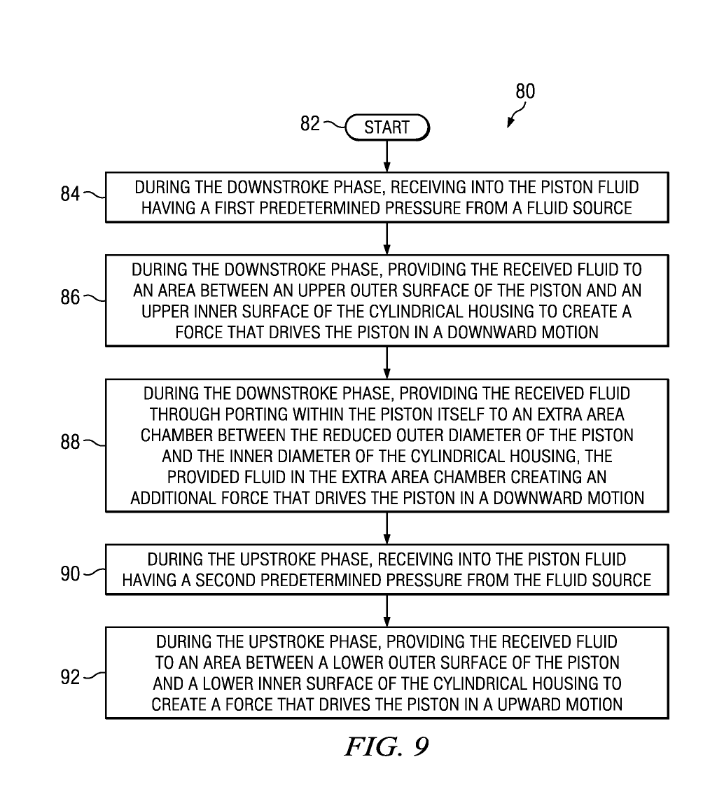

For example, FIG. 9 is a flowchart of a method 80 of operating a down-hole hammer apparatus. The method 80 may begin at block 82. The method 80 may proceed to block 84 where during the downstroke phase, the method 80 may receive into the piston fluid having a first predetermined pressure from a fluid source. From block 84 the method 80 may move to block 86 where during the downstroke phase, the method 80 may provide the received fluid to an area between an upper outer surface of the piston and an upper inner surface of the cylindrical housing to create a force that drives the piston in a downward motion. Then the method 80 may continue to block 88 when during the downstroke phase, the method 80 may provide the received fluid through porting within the piston to an extra area chamber between the reduced outer diameter of the piston and the inner diameter of the cylindrical housing, the provided fluid in the extra area chamber creating an additional force that drives the piston in a downward motion. Further, the method 80 may continue onward to block 90 when during the upstroke phase, the method 80 may receive into the piston fluid having a second predetermined pressure from the fluid source. Then the method 80 may carry on to block 92 where during the upstroke phase, the method 80 may provide the received fluid to an area between a lower outer surface of the piston and a lower inner surface of the cylindrical housing to create a force that drives the piston in an upward motion.

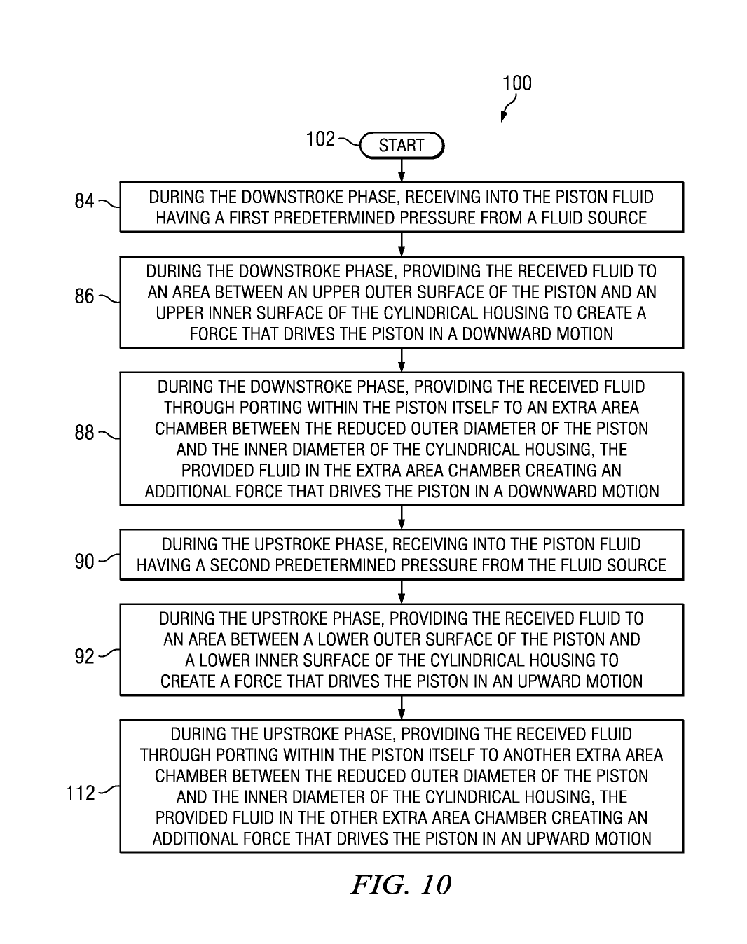

In addition, FIG. 10 is a flowchart of another method 100 of operating a down-hole hammer apparatus. The method 100 is similar to the method 80 (FIG. 9) and therefore the discussion below focuses on the differences. Method 100 may start at block 102 and may proceed to blocks 84, 86, 88, 90, and 92. From block 92, the method 100 may continue to block 112 where the method 100 during the upstroke phase, may provide the received fluid through porting within the piston to another extra area chamber between the reduced outer diameter of the piston and the inner diameter of the cylindrical housing, the provided fluid in the other extra area chamber creating an additional force that drives the piston in an upward motion.

Many other modifications and variations of the embodiments discussed above are possible in light of the above teachings. For instance, the improvements of the embodiments may be utilized in any device in which the energy transfer may have been limited by the area of the internal dimension of a cylinder that houses the device. Likewise, the number of chambers of the orientation may be adjusted. Further, various porting configurations are possible.

The specific embodiments discussed herein are merely illustrative, and are not meant to limit the scope of the present invention in any manner. It is therefore to be understood that within the scope of the disclosed concept, the invention may be practiced otherwise than as specifically described. For example, an extra area down-hole apparatus may be provided using a piston apparatus that is different than the hammer apparatus 10 shown in the aforementioned embodiments, while still comporting with the spirit of the invention. For instance, existing hammers may be modified to include an extra area chamber.

We claim:

1. A down-hole piston driven hammer comprising:
a cylindrical housing having an inner diameter, and a source opening within the cylindrical housing for receiving a source of fluid for creating movement in the piston driven hammer;
a tubular piston having an inner radius, and outer radius, and a reduced outer radius, the tubular piston fitting inside the cylindrical housing such that the outer radius of the tubular piston is movable along and within the inner radius of the cylindrical housing, and the tubular piston having a top surface defining a first pressure chamber between a top portion of the cylindrical housing, and a bottom surface defining a second pressure chamber between a bottom portion of the cylindrical housing;
an extra area component between the housing and the tubular piston such that the reduced outer radius of the tubular piston is movable along the extra area component, and wherein a surface of the extra area component together with the reduced outer radius of the tubular piston and the cylindrical housing defines an extra area chamber;
wherein the tubular piston includes within its body:
a first port in fluid communication with the source opening, the first port extending between the inner and outer diameters of the tubular piston;
a second port in fluid communication with the first port, and that extends from the first port along a portion of the length of the tubular piston; and
a third port in fluid communication with the second port, and that extends from the second port toward the outer diameter of the tubular piston, and in communication with the extra area chamber.

2. The down-hole piston driven hammer of claim 1, wherein the extra area chamber provides force for upstroke phases of the tubular piston.

3. The down-hole piston driven hammer of claim 1, wherein the extra area chamber provides force for downstroke phases of the tubular piston.

4. The down-hole piston driven hammer of claim 1,
wherein the extra area component includes an extra area ring disposed between the inner radius of the cylindrical housing and the reduced outer radius of the tubular piston;
wherein the extra area ring includes upper and lower surfaces defined by the areas between the inner and outer diameters of the extra area ring; and
wherein the extra area chamber is defined by the upper surface of the extra area ring, the reduced outer diameter of the tubular piston, and the inner diameter of the cylindrical housing.

5. The down-hole piston driven hammer of claim 1,
wherein the extra area component includes an extra area ring disposed between the inner radius of the cylindrical housing and the reduced outer radius of the tubular piston;
wherein the extra area ring includes upper and lower surfaces defined by the areas between the inner and outer diameters of the extra area ring; and
wherein the extra area chamber is defined by the lower surface of the extra area ring, the reduced outer diameter of the tubular piston, and the inner diameter of the cylindrical housing.

6. The down-hole piston driven hammer of claim 5, further comprising another extra area chamber defined by the upper surface of the extra area ring, the reduced outer diameter of the tubular piston, and the inner diameter of the cylindrical housing.

7. The down-hole piston driven hammer of claim 6, wherein both extra area chambers are capable of receiving fluid from the same fluid source.

8. The down-hole piston driven hammer of claim 1, wherein the extra area ring is fabricated with a TIR of no more than 0.003 inches.

9. The down-hole piston driven hammer of claim 8, wherein the extra area ring is fabricated using a cut before machining fabrication method.

10. The down-hole piston driven hammer of claim 9, wherein the extra area ring is fabricated with a TIR of no more than 0.001 inches.

11. The down-hole piston driven hammer of claim 1, further comprising:
another extra area chamber;
wherein the extra area ring includes upper and lower surfaces defined by the areas between the inner and outer diameters of the extra area ring;
wherein the extra area chamber is defined by the upper surface of the extra area ring, the reduced outer diameter of the tubular piston, and the inner diameter of the cylindrical housing;
wherein the other extra area chamber is defined by the lower surface of the extra area ring, the reduced outer diameter of the tubular piston, and the inner diameter of the cylindrical housing; and
wherein the tubular piston includes within its body:
a fourth port in fluid communication with the source opening, the fourth port extending between the inner and outer diameters of the tubular piston;
a fifth port in fluid communication with the fourth port, and that extends from the fourth port along a portion of the length of the tubular piston;
a sixth port in fluid communication with the fifth port, and that extends from the fifth port toward the outer diameter of the tubular piston, and in communication with the other extra area chamber.

12. The down-hole piston driven hammer of claim 11, wherein the second and fifth ports are isolated by ninety degrees from one another.

13. The down-hole piston driven hammer of claim 1, wherein the fluid includes a gas.

14. A method of operating a piston driven hammer, the piston driven hammer having a tubular piston with an inner, outer, and reduced outer diameter, the piston being movable within a housing having an inner diameter, and operating in an upstroke phase and a downstroke phase, the method comprising:
during the downstroke phase:
receiving into the piston fluid having a first predetermined pressure from a fluid source;
providing the received fluid to an area between an upper outer surface of the piston and an upper inner surface of the housing to create a force that drives the piston in a downward motion; and
providing the received fluid through porting within the piston to an extra area chamber between the reduced outer diameter of the piston and the inner diameter of the housing, the provided fluid in the extra area chamber creating an additional force that drives the piston in a downward motion; and
during the upstroke phase:
receiving into the piston fluid having a second predetermined pressure from the fluid source; and
providing the received fluid to an area between a lower outer surface of the piston and a lower inner surface of the housing to create a force that drives the piston in an upward motion.

15. The method of claim 14, wherein the first and second predetermined pressures are the same.

16. The method of claim 14, further comprising during the upstroke phase providing the received fluid through porting within the piston to another extra area chamber between the reduced outer diameter of the piston and the inner diameter of the housing, the provided fluid in the other extra area chamber creating an additional force that drives the piston in an upward motion.

17. A pressure operated actuator operating in a first and second phase, comprising:
a housing having a pressure source opening for receiving a source of pressure;
a piston inside the housing such that the piston moves along the inside of the housing and positioned therein so that a first chamber is created between one end of the piston and the housing and a second chamber is created between the other end of the piston and the housing;
a first port capable of being in communication with the pressure source opening during the first phase of the pressure operated actuator;
a second port capable of being in communication with the pressure source opening during the second phase of the pressure operated actuator;
a first extra area chamber between the piston and the housing; and
wherein the pressure source opening and piston are configured in a manner so that:
in the first phase of the pressure operated actuator the first port is in communication with the pressure source opening for receiving the source of pressure and allowing the source of pressure to be provided to the first and first extra area chambers; and
in the second phase of the pressure operated actuator the second port is in communication with the pressure source opening for receiving the source of pressure and allowing the source of pressure to be provided to the second chamber.

18. The pressure operated actuator of claim 17,
wherein the pressure source opening receives one of a source of fluid and gas; and
wherein in the first phase the pressure operated actuator is one of in a downstroke and an upstroke position.

19. The pressure operated actuator of claim 18, further comprising an extra area ring having an inner and outer diameter that is disposed between the piston and the housing and that creates the first extra area chamber, wherein the first extra area chamber is in between the outer side of the piston and the inner side of the housing.

20. The pressure operated actuator of claim 19, wherein the first port extends within the piston for providing pressure to the first extra area chamber.
